(19) United States
(12) Patent Application Publication
(10) Pub. No.: US 2026/0106211 A1
(43) Pub. Date: Apr. 16, 2026

(54) ELECTROLYTE SEPARATOR FOR A SOLID STATE BATTERY

(71) Applicant: OXFORD UNIVERSITY INNOVATION LIMITED, Oxford Oxfordshire (GB)

(72) Inventors: Mauro PASTA, Oxford (Oxfordshire) (GB); Soochan KIM, Oxford (Oxfordshire) (GB)

(21) Appl. No.: 19/114,810

(22) PCT Filed: Oct. 3, 2023
(86) PCT No.: PCT/GB2023/052548

§ 371 Date: Mar. 25, 2025

(30) Foreign Application Priority Data
Oct. 7, 2022 (GB) 2214815.9

(51) Int. Cl. H01M 10/056; H01M 10/052; H01M 50/414; H01M 50/431

(52) U.S. Cl. CPC H01M 10/056; H01M 10/052; H01M 50/414; H01M 50/431; H01M 2300/0065

(57) ABSTRACT

A solid electrolyte separator for an electrochemical storage device is described. The solid electrolyte separator comprises: an electrolyte comprising a lithium-ion conductive compound; and a binder comprising a copolymer, wherein the lithium-ion conductive compound comprises sulfur, and the copolymer has a repeating unit comprising a carboxylic acid group or a conjugate base thereof. Also described is a masterbatch product, a method of manufacturing the solid electrolyte separator and an electrochemical storage device.

### FIELD OF THE INVENTION

The invention relates to a solid electrolyte separator for an electrochemical storage device. The invention also relates to a masterbatch product, a method of manufacturing the solid electrolyte separator and an electrochemical storage device comprising the solid electrolyte separator.

### BACKGROUND

The future of electric transportation relies on novel battery chemistries with higher energy density and lower cost than state-of-the-art Li-ion batteries. Lithium-sulphur batteries (LiSBs) are one of the most promising candidates due to their high theoretical capacity (1675 mAh g⁻¹) and the abundance of sulphur in the earth's crust. Despite decades of research and development, the widespread application of LiSBs remains hindered by the rapid capacity fade caused by polysulphides shuttle and poor Li-metal plating and stripping efficiency.

Replacing the liquid electrolyte with a solid electrolyte is one of the most promising avenues to address these issues. Various materials have been investigated for use as solid electrolytes, and they all have unique pros and cons. Among these, polymers are easy to process, provide good interfacial contact with the active materials and can suppress the polysulphide shuttle. Unfortunately, their limited ionic conductivity, narrow electrochemical stability window, and inability to prevent Li-filamentary growth owing to insufficient mechanical strength, vastly limit their utility. On the other hand, inorganic ceramics possess the electrochemical and mechanical properties necessary to hinder both polysulphides and dendrites. Sulphide solid electrolytes are particularly promising because of their compatibility with sulphur cathodes and superior Li-ion conductivity, which is comparable to liquid electrolytes at room temperature, with the added advantage of being easily processable. With regard to mechanical properties, their soft nature enables easy densification, but brittleness hinders their scalability for use in thin-films.

The present invention aims to mitigate one or more of the aforementioned problems of the prior art.

### SUMMARY OF THE INVENTION

The invention provides a solid electrolyte (SE) separator for an electrochemical storage device, particularly for a solid-state battery (SSB), especially an all-solid-state battery (ASSB). The solid electrolyte separator comprises: an electrolyte comprising a lithium-ion conductive compound; and a binder comprising a copolymer, wherein the lithium-ion conductive compound comprises sulfur and the copolymer has a repeating unit comprising a carboxylic acid group or a carboxylate anion thereof.

Conventional sulfide-based solid electrolytes (SEs) can provide superior Li-ion conductivity but are brittle and do not have adequate mechanical properties for commercial use. The present inventors have discovered that the combination of (i) a lithium-ion conductive compound comprising sulfur and (ii) a binder comprising a copolymer with a repeating unit comprising a carboxylic acid group or a conjugate based thereof, provides a solid electrolyte separator having advantageous mechanical properties, in addition to having excellent electrical properties. The solid electrolyte separator of the invention is flexible and easily processable, whilst having high ionic conductivity. The solid electrolyte separator of the invention is particularly suitable for use with Li-metal anodes.

To this end, the inclusion of the binder defined in accordance with the present invention in the solid electrolyte separator contributes to mechanical properties that allow the solid electrolyte to be provided as a thin separator. The solid electrolyte separator according to the present invention has an increased energy density.

Conventional sulfide-based solid electrolytes can react with polar materials, such as polar solvents or polar binders. For the chemical stability of the sulfide-based solid electrolyte, a non-polar binder should be used, but such binders have poor solubility and show poor compatibility and dispersibility with the ion conductive compound. The use of a non-polar binder generally provides poor cohesion/adhesion with the electrode components and can cause problems during the manufacture of the solid electrolyte separator. The use of a polar binder on the other hand aids processability and provides high adhesivity between the electrolyte and electrode components.

Surprisingly, it has been found that the use of a binder comprising a copolymer having a repeating unit comprising a carboxylic acid group or a conjugate base thereof can provide a solid electrolyte separator that has good adhesion with electrode components and is processable in non-polar solvents, despite the inclusion of a polar functional group in the binder. The electrolyte material in the solid electrolyte separator of the invention can provide stable interfacial electrochemical mechanics with Li metal.

The invention further provides a masterbatch product for preparing a solid electrolyte separator. The masterbatch product comprises a lithium-ion conductive compound; a copolymer; and a solvent. The lithium-ion conductive compound comprises sulfur, and the copolymer has a repeating unit comprising a carboxylic acid group or a conjugate base thereof.

The invention also provides a method of manufacturing a solid electrolyte separator for an electrochemical storage device, the method comprising: (i) mixing a lithium-ion conductive compound, a copolymer and a solvent, wherein the lithium-ion conductive compound comprises sulfur, and the copolymer has a repeating unit comprising a carboxylic acid group or a conjugate base thereof to form a masterbatch product; and (ii) calendaring the masterbatch product to form a separator.

The method of the present invention advantageously provides a simple and highly scalable method for manufacturing a solid electrolyte separator. The sulfide-based solid electrolyte and binder easily form a solid electrolyte-polymer composite without the need of high-energy mixing steps. Without wishing to be bound by theory, it is thought that this results from the formation of polar-polar intermolecular bonds between the carboxylic acid groups of the binder and the solvent. This complex or composite can then be calendared to form thin separators, such as 50 μm or less. The use of a binder in accordance with the invention therefore facilitates the production of a solid electrolyte in the form of a thin separator. Such solid electrolyte separators can achieve high energy densities.

A further aspect of the invention provides an electrochemical storage device. The electrochemical storage comprises: a first electrode, a second electrode and the solid electrolyte separator of the invention disposed between the first electrode and the second electrode.

Advantageously the solid electrolyte separator can easily be assembled into a full cell, for example a lithium-sulfur cell, and is compatible with Li-metal anodes. Furthermore, the cell containing the solid electrolyte separator can advantageously be operated at practical and commercially relevant conditions, for example, 30° C. and <1 MPa stack pressure. The electrochemical performance of the cell is excellent, and may provide superior critical current density and stable cycling, particularly under practical conditions.

### BRIEF DESCRIPTION OF THE DRAWINGS

The invention is further described hereinafter with reference to the accompanying drawings.

FIG. 1a is a schematic representation of the solid electrolyte separator fabrication process.

FIG. 1b shows photos of the final solid electrolyte separator product.

FIG. 1c shows spectra obtained from FT-IR analysis of solid electrolyte separators prepared with 3, 5, and 10 wt. % XNBR binder (TSE-X3, TSE-X5, TSE-X10, respectively).

FIG. 1d shows spectra obtained from Raman spectroscopy of solid electrolyte separators prepared with 3, 5, and 10 wt. % XNBR binder (TSE-X3, TSE-X5, TSE-X10, respectively).

FIG. 1e shows spectra obtained from XRD analysis of solid electrolyte separators prepared with 3, 5, and 10 wt. % XNBR binder (TSE-X3, TSE-X5, TSE-X10, respectively).

FIG. 1f shows results of testing the Young's modulus by compression and ionic conductivity by EIS.

FIG. 2a is a schematic representation of XPS analysis with in-situ Li sputtering.

FIG. 2b displays XPS spectra from the solid electrolyte separator with continual in-situ Li-metal deposition.

FIG. 2c shows XPS spectra of the solid electrolyte pellet with in-situ Li sputtering.

FIG. 3a shows LSV curves of the integrated solid electrolyte and PDOL electrolytes from 2.0 to 5.0 V.

FIG. 3b displays Nyquist plots of Li/thin solid electrolyte/Li cell over time.

FIG. 3c shows Nyquist plots of Li/solid electrolyte pellet/Li cell over time.

FIG. 3d displays a Nyquist plot fitting circuit of FIG. 3b and FIG. 3c.

FIG. 3e shows CCD of various solid electrolytes.

FIG. 3f displays detailed Li plating/stripping curves of Li/solid electrolyte pellet/Li for CCD.

FIG. 3g shows detailed Li plating/stripping curves of Li/thin solid electrolyte/Li for CCD.

FIG. 3h shows cycling results from a symmetric Li-Li cell with the thin solid electrolyte at 0.1 mA cm⁻² for 500 h.

FIG. 3i is a detailed symmetrical Li-Li cycling profile at specific times obtained from FIG. 3h.

FIG. 3j are Nyquist plots of a symmetrical Li-Li cell with the thin solid electrolyte separator after 500 hours of cycling.

FIG. 4a is a schematic representation of an integrated solid-state battery system presented here with a FIB-SEM image of the solid electrolyte separator.

FIG. 4b is a diagrammatic representation of the in-situ polymerisation process.

FIG. 4c is the research trend of solid-state lithium-sulphur batteries according to the battery operating condition.

FIG. 4d shows the photos of PDOL and the weight changes of PDOL after drying.

FIG. 5a shows galvanostatic initial discharge curves of LiSBs with a liquid electrolyte and thin solid electrolyte.

FIG. 5b shows EIS characterization results of solid-state LiSB with a thin solid electrolyte during its first cycle; the left shows the points selected for EIS tests in the voltage profile and the right shows the EIS spectra at the various points across the cycle.

FIG. 5c shows EIS characterization results of solid-state LiSB with liquid electrolyte during its first cycle; the left shows the points selected for EIS tests in the voltage profile and the right shows the EIS spectra at the various points across the cycle.

FIG. 5d shows battery cycling results of a solid-state Li-S coin cell using the TSE.

FIG. 5e shows battery cycling results of a liquid-state Li-S coin cell.

FIG. 5f shows battery cycling results at the different current densities.

### DETAILED DESCRIPTION

### Definitions

It should be understood that unless expressly stated to the contrary, any reference to a repeating unit or monomer, whether represented by a structural formula or otherwise, encompasses all stereoisomers, including cis and trans isomers, as well as optical isomers (e.g. R and S enantiomers), of the repeating unit or the monomer, respectively.

The various hydrocarbon-containing moieties provided herein may be described using a prefix designating the minimum and maximum number of carbon atoms in the moiety, e.g. “C_{a-b}”. For example, C_{a-b}alkyl indicates an alkyl moiety having the integer “a” to the integer “b” number of carbon atoms, inclusive.

The terms “alkyl” and “alkyl group” as used herein refer to a branched or unbranched saturated hydrocarbon chain. Unless specified otherwise, alkyl groups typically contain 1 to 4 carbon atoms and are unsubstituted. Representative examples include, but are not limited to, methyl, ethyl, n-propyl, i-propyl, n-butyl, i-butyl, s-butyl and t-butyl.

The terms “alkylene” and “alkylene group” as used herein refer to a linear, saturated hydrocarbon chain. The hydrocarbon chain is unbranched unless specified otherwise, such as when it is substituted with another group. Unless specified otherwise, alkylene groups typically contain 2 to 4 carbon atoms, such as 2, 3 or 4 carbon atoms, and can be substituted or unsubstituted. Representative examples include, but are not limited to, ethylene (—CH₂CH₂—) and propylene (—CH₂CH₂CH₂—).

The terms “alkenylene” and “alkenylene group” as used herein refer to a linear hydrocarbon chain containing at least one double bond, preferably a single double bond. The hydrocarbon chain is unbranched unless specified otherwise, such as when it is substituted with another group. Unless specified otherwise, alkenyl groups typically contain 2 to 4 carbon atoms, such as 2, 3 or 4 carbon atoms, and can be substituted or unsubstituted. Representative examples include, but are not limited to, ethenyl, propen-1-yl, propen-2-yl and buten-3-yl.

The terms “phenyl” and “phenyl group” as used herein refers to an unsubstituted phenyl ring.

The terms “a” or “an” have an open meaning and when used in relation to a feature allow one or more of that feature to be present. As such, the terms “a” or “an” include “one or more” and “at least one” and can be used interchangeably therewith.

The term “comprises” or “comprising” as used herein has an open meaning and includes the semi-closed term “consisting essentially of” and the closed term “consisting of” and can be used interchangeably therewith.

### Binder and Copolymer

The solid electrolyte separator comprises a binder. The binder comprises, or may consist essentially of, a copolymer.

The term “copolymer” as used herein has its conventional meaning in the art. This term refers to a polymer formed when at least two different monomers (e.g. two monomers having a different composition) are linked in the same polymer chain.

The copolymer may be an alternating copolymer, a block copolymer or a graft copolymer. It is preferred that the copolymer is a block copolymer or a graft copolymer, more preferably a block copolymer.

In general, the copolymer is a bipolymer, a terpolymer or a quaterpolymer. It is preferred that the copolymer is a bipolymer or a terpolymer, more preferably a terpolymer. The copolymer is typically a block copolymer when it is a biopolymer, a terpolymer or a quaterpolymer.

The copolymer has a repeating unit comprising a carboxylic acid group (e.g. —COOH) or a conjugate base thereof. The conjugate base of the carboxylic acid group is a carboxylate anion (e.g. —COO—). The carboxylate anion may have a counter-cation. It is preferred that the counter-cation is a cation of lithium (e.g. Li⁺). This may be advantageous when the solid electrolyte separator is used in Li-ion batteries.

For ease of reference, the repeating unit comprising a carboxylic acid group or a conjugate base thereof is referred to herein as the “first repeating unit”. The label “first” in this context is used to differentiate this repeating unit from the other repeating units discussed herein below. The term “first” in this context should not be construed as imparting a limitation, whether structural or functional, to the repeating unit.

The copolymer, particularly the first repeating unit, may be derived or obtained from a first monomer. The first repeating unit may be directly derived or directly obtained from the first monomer. In other words, the first monomer is not subjected to any other chemical transformation prior to its use in forming the first repeating unit of the copolymer. As above, the label “first” in this context is used to differentiate this monomer from the other monomers discussed herein below.

The first monomer may comprise a carboxylic acid group or a conjugate base thereof. The carboxylic acid group or the conjugate base thereof in the first monomer is typically the carboxylic acid group or the conjugate base thereof of the first repeating unit. The carboxylic acid group or the conjugate base thereof is a polar functional group. Thus, the part of the copolymer comprising the first repeating unit is relatively polar.

The first monomer may be (or the first repeating unit may be derived or obtained from) acrylic acid, methacrylic acid or maleic acid, preferably acrylic acid or methacrylic acid, more preferably methacrylic acid.

Additionally or alternatively, the first monomer may comprise a hydrolysable precursor group for forming a carboxylic acid group or a conjugate base thereof. The hydrolysable precursor group is for forming the carboxylic acid group or the conjugate base thereof of the first repeating unit.

The hydrolysable precursor group may be a carboxylate ester group, a carboxylate anhydride group or a carboxylate amide group. After polymerisation of the first monomer comprising the hydrolysable precursor group, the resulting polymer may be subjected to a hydrolysis conditions to convert the hydrolysable precursor group into the carboxylic acid group or a conjugate base thereof.

The first monomer may be (or the first repeating unit may be derived or obtained from) a carboxylate ester, anhydride or amide of acrylic acid, methacrylic acid or maleic acid, preferably a carboxylate ester, anhydride or amide of acrylic acid or methacrylic acid, more preferably a carboxylate ester, anhydride or amide of methacrylic acid.

Generally, it is preferred the first repeating unit comprises a carboxylic acid group, preferably as the only functional group of the repeating unit. In other words, the first repeating unit does not comprise any other functional group or groups.

The first repeating unit may have a structure as represented by formula (1):

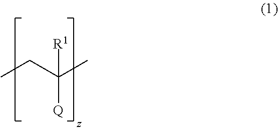

wherein:
R¹ is hydrogen or methyl;
Q is selected from a carboxylic acid group (—COOH) or a conjugate base thereof, and a hydrolysable precursor group for forming a carboxylic acid group or a conjugate base thereof; and
z is greater than 1.

In the definition of Q, the “conjugate base thereof” and the “hydrolysable precursor group” are as define herein above.

It is preferred that the first repeating unit is of formula (1a) or formula (1b), preferably formula (1b):

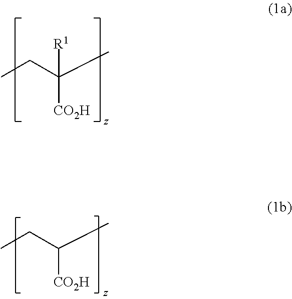

wherein R¹ (where present in formula (1a)) and z are as defined above in respect of formula (1).

In formula (1) and formula (1a), it is preferred that R¹ is hydrogen.

In each of formula (1), formula (1a) and formula (1b), the parameter “z” represents the number of first repeating units in the copolymer.

For an individual copolymer molecule, then z represents an integer number of repeating units, which is greater than 1.

However, when there is a plurality of copolymer molecules, as comprised in the binder of the solid electrolyte separator of the invention, then there is a distribution in the number of repeating units represented by formula (1), formula (1a) and formula (1b). The parameter “z” may then be provided as a mean number such that the copolymer has a total content of the carboxylic acid group and the conjugate base thereof of between 1 and 15 wt % (e.g. of the total weight of the copolymer). More preferably, the parameter “z” may be provided as a mean number such that the copolymer has a total content of the carboxylic acid group and the conjugate base thereof of from 5 to 12.5 wt % (e.g. of the total weight of the copolymer). Even more preferably, the parameter “z” may be provided as a mean number such that the copolymer has a total content of the carboxylic acid group and the conjugate base thereof of from 7 to 10 wt % (e.g. of the total weight of the copolymer). Even more preferably still, the parameter “z” may be provided as a mean number such that the copolymer has a total content of the carboxylic acid group and the conjugate base thereof of 10 wt % (e.g. of the total weight of the copolymer).

The copolymer may comprise a second repeating unit. The second repeating unit has a different chemical structure to the chemical structure of the first repeating unit.

The label “second” in the context of the “second repeating unit” or the “second monomer” is used to differentiate the repeating unit or the monomer, respectively, from other repeating units or monomers discussed herein. The term “second” in this context should not be construed as imparting a limitation, whether structural or functional, to the repeating unit or the monomer, respectively.

The second repeating unit is a hydrocarbyl repeating unit. The hydrocarbyl repeating unit is a non-polar part of the copolymer. Thus, the part of the copolymer comprising the second repeating unit is non-polar.

Typically, the hydrocarbyl repeating unit has a backbone. The backbone may comprise 2 or more carbon atoms and is optionally substituted with one or more side groups. It is preferred that the backbone is optionally substituted with a single (e.g. only one) side group.

The backbone is the constituent element of the second repeating unit that forms the main polymer chain of at least part of the copolymer. A side group is a group that is covalently bonded to the backbone, which does not form part of the main polymer chain.

The second repeating may be represented by formula (2):

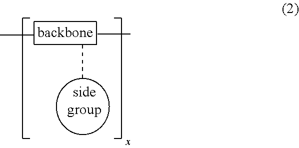

where the dashed bond indicates that the presence of the side group is optional (e.g. the side group is an optional substituent).

In general, or in formula (2), the backbone may be selected from a C₂₋₄alkylene group and a C₂₋₄alkenylene group, where the backbone is optionally substituted by a side group, preferably a single side group.

Generally, or in formula (2), the side group may be selected from a C₁₋₄alkyl group and a phenyl group.

In formula (2), x is greater than 1.

It is preferred that the backbone is selected from a C₂₋₃alkylene group and a C₃₋₄alkenylene group, more preferably the backbone is selected from a C₂alkylene group and a C₄alkenylene group.

It is generally preferred that the side group is selected from a C₁₋₂alkyl group and a phenyl group, more preferably the side group is selected from a methyl group and a phenyl group.

When the backbone is a C₂alkylene group, then it is preferred that this backbone is either unsubstituted or substituted with a single side group selected from methyl, ethyl and phenyl, preferably methyl and phenyl.

When the backbone is a C₄alkenylene group, then it is preferred that this backbone is unsubstituted.

The second repeating unit may be represented by one of formulae (2a), (2b) or (2c), preferably formula (2c):

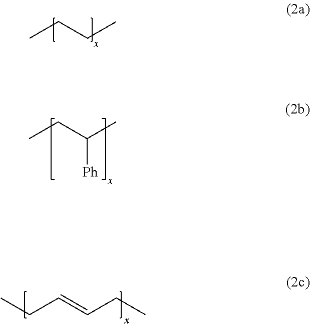

The term “Ph” represents a phenyl group and x is as defined herein.

For an individual copolymer molecule, then x represents an integer number of repeating units, which is greater than 1.

When there is a plurality of copolymer molecules, as comprised in the binder of the solid electrolyte separator of the invention, then there is a distribution in the number of repeating units represented by formula (2) or formulae (2a) to (2c). When only the second repeating unit represented by formula (2) or formulae (2a) to (2c) is present in addition to the first repeating unit, the parameter “x” may then be provided as a mean number such that the copolymer has a total content of the second repeating unit represented by formula (2) or formulae (2a) to (2c) of from 85 to 99 wt % (e.g. of the total weight of the copolymer). Preferably, the parameter “x” may then be provided as a mean number such that the copolymer has a total content of the second repeating unit represented by formula (2) or formulae (2a) to (2c) of from 87.5 to 95 wt % (e.g. of the total weight of the copolymer). Even more preferably, the parameter “x” may then be provided as a mean number such that the copolymer has a total content of the second repeating unit represented by formula (2) or formulae (2a) to (2c) of from 90 to 93 wt % (e.g. of the total weight of the copolymer). Even more preferably still, the parameter “x” may then be provided as a mean number such that the copolymer has a total content of the second repeating unit represented by formula (2) or formulae (2a) to (2c) of 90 wt % (e.g. based on the total weight of the copolymer).

The copolymer may comprise a third repeating unit. The third repeating unit has a different chemical structure to the chemical structure of the first repeating unit.

The third repeating unit may have a chemical structure that is the same or different to the chemical structure of the second repeating unit.

When the second and third repeating units share the same chemical structure, then it is preferred that the second repeating unit is not directly bonded to the third repeating unit. More preferably, the first repeating unit is disposed between the second repeating unit and the third repeating unit in the copolymer.

In general, it is preferred that the third repeating unit has a different chemical structure to the chemical structure of the second repeating unit.

The label “third” in the context of the “third repeating unit” or the “third monomer” is used to differentiate the repeating unit or the monomer, respectively, from other repeating units or monomers discussed herein. The term “third” in this context should not be construed as imparting a limitation, whether structural or functional, to the repeating unit or the monomer, respectively. For example, the presence of a “third repeating unit” does not require the presence of a “second repeating unit”.

The third repeating unit may have a structure as represented by formula (3):

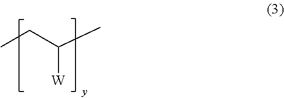

wherein:
W is selected from a nitrile group (e.g. —CN) and a phenyl group; and
y is greater than 1.

Depending on the identity of W, the third repeating unit can be non-polar (e.g. when W is a phenyl group) or moderately polar (e.g. when W is a nitrile group).

Thus, the third repeating unit may be represented by formula (3a) or formula (3b):

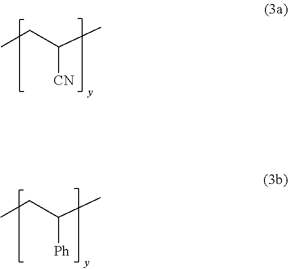

wherein y is as define herein.

For an individual copolymer molecule, then y represents an integer number of repeating units, which is greater than 1.

When there is a plurality of copolymer molecules, as comprised in the binder of the solid electrolyte separator of the invention, then there is a distribution in the number of repeating units represented by formula (3), formula (3a) and formula (3b). When only the third repeating unit represented by formula (3), formula (3a) and formula (3b) is present in addition to the first repeating unit, the parameter “y” may then be provided as a mean number such that the copolymer has a total content of the third repeating unit represented by formula (3), formula (3a) and formula (3b) of from 85 to 99 wt % (e.g. of the total weight of the copolymer). Preferably, the parameter “y” may then be provided as a mean number such that the copolymer has a total content of the third repeating unit represented by formula (3), formula (3a) and formula (3b) of from 87.5 to 95 wt % (e.g. of the total weight of the copolymer). Even more preferably, the parameter “y” may then be provided as a mean number such that the copolymer has a total content of the third repeating unit represented by formula (3), formula (3a) and formula (3b) of from 90 to 93 wt % (e.g. of the total weight of the copolymer). Even more preferably still, the parameter “y” may then be provided as a mean number such that the copolymer has a total content of the third repeating unit represented by formula (3), formula (3a) and formula (3b) of 90 wt % (e.g. based on the total weight of the copolymer).

The copolymer, particularly the third repeating unit, may be derived or obtained from a third monomer. The third repeating unit may be directly derived or directly obtained from the third monomer. In other words, the third monomer is not subjected to any other chemical transformation prior to its use in forming the third repeating unit of the copolymer.

The third monomer may be (or the third repeating unit may be derived or obtained from) styrene or acrylonitrile.

The copolymer comprises a first repeating unit and at least one of a second repeating unit and a third repeating unit. Thus, the copolymer may comprise a first repeating unit and either (i) a second repeating unit, or (ii) a third repeating unit, or (iii) a second repeating unit and a third repeating unit.

In embodiments where the copolymer comprises a first repeating unit, a second repeating unit and a third repeating unit, the parameter “z” may be provided as a mean number such that the copolymer has a total content of the carboxylic acid group and the conjugate base thereof of from 1 to 15 wt % (e.g. of the total weight of the copolymer), parameter “x” may then be provided as a mean number such that the copolymer has a total content of the second repeating unit of from 42.5 to 79 wt % (e.g. of the total weight of the copolymer) and parameter “y” may then be provided as a mean number such that the copolymer has a total content of the third repeating unit of from 20 to 42.5 wt % (e.g. of the total weight of the copolymer). Preferably, parameter “z” may be provided as a mean number such that the copolymer has a total content of the carboxylic acid group and the conjugate base thereof of from 5 to 12.5 wt % (e.g. of the total weight of the copolymer), parameter “x” may then be provided as a mean number such that the copolymer has a total content of the second repeating unit of from 47.5 to 65 wt % (e.g. of the total weight of the copolymer) and parameter “y” may then be provided as a mean number such that the copolymer has a total content of the third repeating unit of from 30 to 40 wt % (e.g. of the total weight of the copolymer). More preferably, parameter “z” may then be provided as a mean number such that the copolymer has a total content of the carboxylic acid group and the conjugate base thereof of from 7 to 10 wt % (e.g. of the total weight of the copolymer), parameter “x” may then be provided as a mean number such that the copolymer has a total content of the second repeating unit of from 51 to 60 wt % (e.g. of the total weight of the copolymer) and parameter “y” may then be provided as a mean number such that the copolymer has a total content of the third repeating unit of from 33 to 39 wt % (e.g. of the total weight of the copolymer). Even more preferably the parameter “z” may then be provided as a mean number such that the copolymer has a total content of the carboxylic acid group and the conjugate base thereof of 10 wt % (e.g. of the total weight of the copolymer), parameter “x” may then be provided as a mean number such that the copolymer has a total content of the second repeating unit of 51 wt % (e.g. of the total weight of the copolymer) and parameter “y” may then be provided as a mean number such that the copolymer has a total content of the third repeating unit of 39 wt % (e.g. of the total weight of the copolymer).

In other embodiments still, when the copolymer comprises a first repeating unit, a second repeating unit and a third repeating unit, the parameter “z” may then be provided as a mean number such that the copolymer has a total content of the carboxylic acid group and the conjugate base thereof of from 1 to 15 wt % (e.g. of the total weight of the copolymer), parameter “x” may then be provided as a mean number such that the copolymer has a total content of the second repeating unit of from 20 to 42.5 wt % (e.g. of the total weight of the copolymer) and parameter “y” may then be provided as a mean number such that the copolymer has a total content of the third repeating unit of from 42.5 to 79 wt % (e.g. of the total weight of the copolymer). Preferably, the parameter “z” may be provided as a mean number such that the copolymer has a total content of the carboxylic acid group and the conjugate base thereof of from 5 to 12.5 wt % (e.g. of the total weight of the copolymer), parameter “x” may then be provided as a mean number such that the copolymer has a total content of the second repeating unit of from 30 to 40 wt % (e.g. of the total weight of the copolymer) and parameter “y” may then be provided as a mean number such that the copolymer has a total content of the third repeating unit of from 47.5 to 65 wt % (e.g. of the total weight of the copolymer). More preferably, the parameter “z” may then be provided as a mean number such that the copolymer has a total content of the carboxylic acid group and the conjugate base thereof of from 7 to 10 wt % (e.g. of the total weight of the copolymer), parameter “x” may then be provided as a mean number such that the copolymer has a total content of the second repeating unit of from 33 to 39 wt % (e.g. of the total weight of the copolymer) and parameter “y” may then be provided as a mean number such that the copolymer has a total content of the third repeating unit of from 51 to 60 wt % (e.g. of the total weight of the copolymer). Even more preferably the parameter “z” may then be provided as a mean number such that the copolymer has a total content of the carboxylic acid group and the conjugate base thereof of 10 wt % (e.g. of the total weight of the copolymer), parameter “x” may then be provided as a mean number such that the copolymer has a total content of the second repeating unit of 39 wt % (e.g. of the total weight of the copolymer) and parameter “y” may then be provided as a mean number such that the copolymer has a total content of the third repeating unit of 51 wt % (e.g. of the total weight of the copolymer).

When the copolymer comprises a second repeating unit and a third repeating unit, then it is preferred that the third repeating unit has a different chemical structure to the chemical structure of the second repeating unit.

When the second repeating unit is of formula (2b), then it is preferred that the third repeating unit is of formula (3a).

It is generally preferred that when the copolymer comprises a second repeating unit and the third repeating unit, then the second repeating unit is of formula (2c).

The copolymer may comprise, or consist essentially, of a structure represented by formula (4), formula (5) or formula (6):

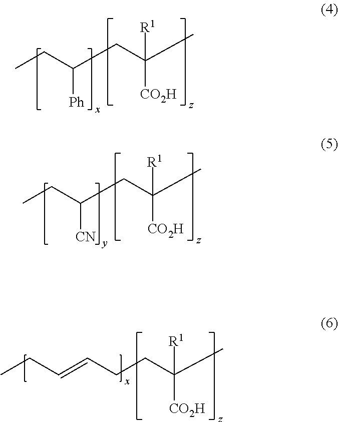

wherein R¹, x (where present), y (where present) and z are as defined herein.

It is preferred that the copolymer comprises, or consists essentially of, a structure represented by formula (7):

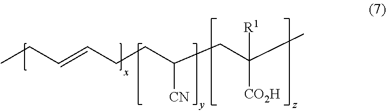

In general, the copolymer is a carboxylated rubber, poly(ethylene-co-acrylic acid), poly(ethylene-co-methacrylic acid) or carboxylated polystyrene. It is preferred that the copolymer is a carboxylated rubber, poly(ethylene-co-methacrylic acid) or carboxylated polystyrene, more preferably the copolymer is a carboxylated rubber.

The term “rubber” as used herein, particularly in the context of a carboxylated rubber generally refers to a synthetic rubber, and not a natural rubber. The synthetic rubber is typically a butadiene rubber (BR).

The carboxylated rubber may be a carboxylated polybutadiene, a carboxylated nitrile butadiene rubber or a carboxylated styrene butadiene rubber. It is preferred that the carboxylated rubber is a carboxylated nitrile butadiene rubber.

In general, the copolymer has a total content of the carboxylic acid group and the conjugate base thereof of less than or equal to 15 wt % (e.g. of the total weight of the copolymer). It is preferred that the copolymer has a total content of the carboxylic acid group and the conjugate base thereof of less than 15 wt % (e.g. of the total weight of the copolymer), more preferably less than or equal to 10 wt %, even more preferably less than 10 wt %. For example, the copolymer may have a total content of the carboxylic acid group and the conjugate base thereof of from 1 to 15 wt % (e.g. of the total weight of the copolymer), preferably of from 5 to 12.5 wt % (e.g. of the total weight of the copolymer), even more preferably of from 7 to 10 wt % (e.g. of the total weight of the copolymer).

Typically, the copolymer has a total content of the carboxylic acid group and the conjugate base thereof of 1, 2, 3, 4, 5, 6, 7, 8 or 9 wt % (e.g. of the total weight of the copolymer).

The copolymer of the invention, especially carboxylated nitrile butadiene rubber, have advantageous properties. Some of these properties result from the polar (e.g. from the —CN and —COOH groups) and the non-polar parts of the copolymer molecule. The copolymers also have elastic and adhesive properties, and are compatible with nonpolar solvents, despite the inclusion of the polar functional groups in at least one of its repeating units. This is surprising because other polymeric binders with polar functional groups (e.g. polyvinylidene fluoride, polyacrylic acid) show high reactivity toward sulfide-based solid electrolyte materials, such as LPSCl.

It is preferred that the copolymer is soluble in a non-polar solvent, such as toluene, (e.g. at 25° C.). Preferably, the polarity index of the solvent is less than 4.0 based on Snyder's polarity index (e.g. as set out in “Classification of the Solvent Properties of Common Liquids, L. R. Snyder., Journal of Chromatography, 92 (1978), 223-224”). Even more preferably the polarity index is less than 3.0, and even more preferably still the polarity index is less than 2.5. Typically, the polarity index is measured at ambient temperatures, for example, room temperature, (e.g. between 2° and 30° C., particularly 25° C.) and at atmospheric pressure, (e.g. 1 atmosphere).

Generally, the solid electrolyte separator comprises the binder in a total amount of from 0.50 to 20.00 wt % (e.g. of the total weight of the solid electrolyte separator), preferably 1.00 to 15.00 wt %, more preferably 3.00 to 10.00 wt %, such as 3.50 to 7.50 wt % (e.g. about 5.00 wt %). Any total amount of binder between the aforementioned values is envisioned. For example, the binder may be present in the solid electrolyte separator in a total amount of 4.00, 5.00, 6.00, 7.00, 8.00, and 9.00 wt % or any range thereof.

For solid electrolyte separators having a binder content of below 3 wt %, the amount of binder can be insufficient to collate the solid electrolyte particles, which may result in flaky composites. On the other hand, a solid electrolyte separator comprising a binder in excess of 10 wt % can be too sticky to process.

### Electrolyte and Lithium-Ion Conductive Compound

The solid electrolyte separator comprises an electrolyte, preferably a solid electrolyte.

The electrolyte, particularly the solid electrolyte, may comprise, or consist essentially, of a lithium-ion conductive compound, which comprises sulfur.

Typically, the solid electrolyte is a sulfide solid electrolyte, which comprises a lithium-ion conductive compound. Such sulfide solid electrolytes are known in the art.

The electrolyte, particularly the sulfide solid electrolyte, may be an argyrodite lithium ionic conductor of the general formula Li₇₋ₚBS₆₋ₚXₚ, wherein B is phosphorous or arsenic, X is Cl, Br or I, and p is between 0 and 1.

It is preferred that B is phosphorous.

Preferably, X is Cl or Br.

It is preferred that p is 1.

More preferably, the electrolyte, particularly the sulfide solid electrolyte, is Li₆PS₅Cl (LPSCl) or Li₆PS₅Br (LPSBr), even more preferably Li₆PS₅Cl (LPSCl).

The electrolyte, particularly the sulfide solid electrolyte, may be of the general formula Li_{4-q}Ge_{(1-q)}P_{q}S₄, where q is between 0 and 1. Such materials are typically known as thio-LISICON materials.

The electrolyte, particularly the sulfide solid electrolyte, may be selected from Li₂S—P₂S₅—LiCl, Li₂S—SiS₂, LiI—Li₂S—SiS₂, LiI—Li₂S—P₂S₅, LiI—Li₂S—P₂O₅, LiI—Li₃PO₄—P₂S₅, Li₂S—P₂S₅, Li₃PS₄, Li₇P₃S₁₁, LiI—Li₂S—B₂S₃, Li₃PO₄—Li₂S—Si₂S, Li₃PO₄—Li₂S—SiS₂, LiPO₄—Li₂S—SiS, Li₁₀GeP₂S₁₂, Li_{9.54}Si_{1.74}P_{1.44}S_{11.7}Cl_{0.3}, Li₇P₃S₁₁, LixPS_{y}Cl_{z}, LiₓPS_{y}Br_{z}, LiₓPS_{y}Cl_{z}Br_{1-z}, LiₓPS_{y}F_{z}, LiₓPS_{y}F_{z}Cl_{1-z} and LiₓPS_{y}F_{z}Br_{1-z}. For LiₓPS_{y}Cl_{z}, LiₓPS_{y}Br_{z}, LiₓPS_{y}Cl_{z}Br_{1-z}, LiₓPS_{y}F_{z}, LiₓPS_{y}F_{z}Cl_{1-z} and LiₓPS_{y}F_{z}Br_{1-z}, x, y and z is each greater than 0.

### Solid Electrolyte Separator

Typically, the solid electrolyte separator comprises a thickness of 50 μm or less. For example, the solid electrolyte separator may comprise a thickness of from 1 to 50 μm, preferably 2 to 30 μm. The reference to thickness in this context refers to the maximum thickness of the solid electrolyte as measured

The solid electrolyte separator may have a thickness of 40 μm, or 30 μm, or 20 μm or 10 μm, or for example, 5 microns. Advantageously, the solid electrolyte separator may comprise a thickness of 50 microns or less which contributes to the solid electrolyte separator having a high energy density.

The solid electrolyte separator typically has an ionic conductivity of from 0.1 to 1.0 mS cm⁻¹, such as 0.3 to 0.75 mS cm⁻¹.

The solid electrolyte separator may have a Young's modulus of from 0.5 to 5 GPa, preferably 1 to 3 GPa, as measured according to the method set out in ASTM D695.

### Masterbatch Product

The invention also provides a masterbatch product. The masterbatch product comprises the lithium-ion conductive compound and the copolymer as described hereinbefore.

The masterbatch product further comprises a solvent. The solvent is preferably a non-polar solvent.

The non-polar solvent may be an aromatic non-polar solvent. For example, the aromatic non-polar solvent may be toluene, xylene or benzene.

Alternatively, the non-polar solvent may be an aliphatic non-polar solvent. For example, the aliphatic non-polar solvent may be pentane, hexane or heptane.

Typically, the masterbatch product comprises the solvent in a total amount of from 1 to 50 wt. % (e.g. of the total weight of the masterbatch product).

Advantageously, the master-batch product can be formed without the need for high energy mixing. Without wishing to be bound by theory, this is thought to result from accelerated formation of polar-polar intermolecular bonds between the carboxylic acid groups of the copolymer in the solvent. When the solvent is a non-polar solvent, such as toluene, the intermolecular interactions between the polar functional groups are enhanced and are not screened by solvation effects of the non-polar solvent.

### Method of Manufacture

The invention also provides a method of manufacturing a solid electrolyte separator. The method comprises, or may consist essentially of, (i) mixing a lithium-ion conductive compound, a copolymer and a solvent (e.g. to form a masterbatch product, such as described hereinbefore) and (ii) calendaring the masterbatch product mixture to form a separator. The lithium-ion conductive compound, the copolymer and the solvent are as described hereinbefore.

The step of mixing the lithium-ion conductive compound, the copolymer and the solvent may be a step of dispersing the lithium-ion conductive compound and the copolymer in the solvent.

The calendaring the masterbatch product may be performed to form a separator having a thickness of 50 microns or less, particularly a thickness as described hereinabove.

The step of calendaring the masterbatch product may be a step of passing the masterbatch product through rollers to form a separator.

Advantageously, the method of the invention is simple and may only comprise basic processing steps to form the solid electrolyte separator. Therefore the solid electrolyte separator may advantageously be produced using a simple and scalable manufacturing method.

Preferably, the forming of the masterbatch product (for example, step one of the method) is conducted at ambient temperatures, for example, room temperature, (e.g. between 2° and 30° C., particularly 25° C.) and at atmospheric pressure, (e.g. 1 atmosphere).

As mentioned hereinbefore, the solvent is preferably a non-polar solvent.

The non-polar solvent may be an aromatic non-polar solvent. For example, the aromatic non-polar solvent may be toluene, xylene or benzene.

Alternatively, the non-polar solvent may be an aliphatic non-polar solvent. For example, the aliphatic non-polar solvent may be pentane, hexane or heptane.

### Electrochemical Storage Device

The invention also provides an electrochemical storage device. The electrochemical storage device comprises a first electrode, a second electrode and a solid electrolyte separator disposed between the first electrode and the second electrode. The solid electrolyte separator is in accordance with the invention.

Typically, the electrochemical storage device is a solid state battery (SSB), preferably an all solid state battery (ASSB).

The second electrode has a different composition to the composition of the first electrode. This is to ensure that an electrical potential difference can exist between the first electrode and the second electrode.

In general, the first electrode is a cathode and the second electrode is an anode.

Typically, the first electrode or cathode comprises sulphur. Preferably, the first electrode or cathode is a tape-cast sulphur electrode.

In principle, any type of second electrode may be used in the electrochemical energy storage device, particularly a second electrode comprising lithium. Typically, the second electrode or anode comprises lithium.

The second electrode or anode comprising lithium may comprise a lithium metal electrode or an alloy of lithium with silicon. It is preferred that the second electrode is a lithium metal electrode.

The electrochemical energy storage device may include a charger, as part of a system. The charger has the function of recharging the electrochemical energy storage device, especially when it is an all solid-state battery.

Typically, after assembly of the electrochemical storage device, the solid electrolyte separator according to the first aspect of the invention is integrated with a supporting electrolyte.

In the electrochemical storage device, the solid electrolyte separator typically further comprises an integrated supporting electrolyte. The integrated supporting electrolyte comprises an ionically conductive polymer. For example, the integrated supporting electrolyte comprises a polydioxolane (PDOL) supporting electrolyte.

Advantageously, and without wishing to be bound by theory, it is thought that the integrated supporting electrolyte provides chemically stable and ionically conducting pathways across electrode-electrolyte interfaces. Thus, the need to operate the cell under high stack pressures to enable sufficient contact between the solid electrolyte and the electrodes is mitigated. Advantageously, the cell can be operated at low stack pressures, for example, 1 MPa or less. Accordingly, a cell operable at more convenient conditions is provided.

The electrochemical storage device may comprise stable cycling of at least 100 cycles measured at 30° C. and <1 MPa stack pressure, for example, at least 200 cycles, at least 500 cycles and at least 800 cycles.

### EXAMPLES

### Preparative Methods and Characterisation Details

### 1. Synthesis of Solid Electrolyte Separator

Li₆PS₅Cl (LPSCl, 99.9%, ˜1 μm, obtained from Ampcera Inc.) and a carboxylated nitrile butadiene rubber (XNBR, Krynac® X750 obtained from Arlanxeo) binder (3 wt %) were combined in anhydrous toluene (99.8%, obtained from Sigma Aldrich) and mixed using a vortex mixer or agate mortar and pestle. As soon as the LPSCl and XNBR were mixed, a composite solid electrolyte (SE) was formed.

The resulting composite was placed between Si-coated polyethylene terephthalate films (PET, thickness 50 μm) and the composite was formed into a film via repeated calendaring. The thickness of the solid electrolyte film was controlled by the calendaring machine settings (MTI corp., MSK-2150). The toluene volatilises after calendaring, such that a negligible amount (<1 wt %) of toluene remains in the solid electrolyte material post-calendaring.

After drying the film under vacuum at room temperature overnight, the separator was cold-pressed by placing them between stainless steel plungers and applying uni-axial pressure of 200 MPa for 3 minutes.

All of the preparation steps were carried out in an Ar-filled glove box (MBRAUN, MB 200B, H₂O <0.1 ppm, O₂ <0.1 ppm).

The above process for preparing the solid electrolyte separator was repeated twice more, with the only difference being that the carboxylated nitrile butadiene rubber content was varied to 5 wt % and 10 wt % in each respective preparation. Thus, hereinafter, sample TSE-X3 contained 3 wt % carboxylated nitrile butadiene rubber; sample TSE-X5 contained 5 wt % carboxylated nitrile butadiene rubber and sample TSE-X10 contained 10 wt % carboxylated nitrile butadiene rubber

### 2. Preparation of Cathode-Supported-Electrolyte (Catholyte)

The solid electrolyte separator (prepared using the method under section 1) was assembled into a cell.

Catholyte was injected to the tape-cast sulphur cathode in the cell-assembly step. To prepare the catholyte, infiltration followed by in-situ polymerisation was carried out by infiltrating 10 μL of 2M lithium bis(fluorosulfonyl)imide (LiFSI) in 1,3-dioxolane (DOL) solution per 1 mg⁻² of sulphur loading. This solution was formed by combining dry DOL (dried by molecular sieves for 24 h) and LiFSI (dried under vacuum at 70° C. for 24 h).

After infiltration, the assembled cell was stored at room temperature for 6 hours. All processing steps were conducted in an Ar-filled glove box.

### 3. Characterisation Methods

All characterisation techniques were conducted without exposure to air and at a temperature of 30° C.

Fourier-transform infrared spectroscopy (FT-IR, NICOLET iS50, Thermo Fisher Scientific) was carried out in the spectral range of 3200-1200 cm⁻¹ using attenuated total reflection (ATR) mode.

X-ray diffraction (XRD, Miniflex, Rigaku) with Cu Kα radiation was used to analyse the structure of the LPSCl powder and solid electrolyte separators after covering the samples with polyimide film to avoid exposure to air.

Raman spectroscopy measurements were collected using a Raman microscope (in via Reflex coupled with an inverted Leica microscope, Renishaw), with a 633 nm laser as the excitation source (power <300 μW) focused onto the sample using a ×50 objective (Olympus). The samples were covered by glass and polyimide film to avoid exposure to air. The collected Raman spectra were baseline corrected and peak fitted using a combined Lorentizian and Gaussian function. The spectral measurement time was 2 s with 24 accumulations to ensure good signal to noise ratio to resolve peaks.

X-ray photoelectron spectroscopy (XPS) spectra were collected using a Phi XPS VersaProbe Ill with an Al Kα X-ray source. For XPS measurements during in-situ Li deposition, sputtering of the Li-metal foil (Sigma-Aldrich, thickness=380 μm) was performed using an acceleration voltage of 2 kV and an Ar⁺ beam current of 1 μA. The angle between the sputter gun and sample surface was 33°. The estimated sputtering depth rate was 0.7 Å min⁻¹, hence the thickness of Li after deposition was approximately 14 nm. The solid electrolyte (pellet and separator) and Li metal were transferred to the XPS chamber using vacuum transfer vessels to eliminate air exposure.

Plasma focused ion beam scanning electron microscopy (PFIB-SEM) sectioning was used to characterize the cross-section morphology of the electrode. PFIB sectioning was performed using a Thermo Fisher Helios G4 Plasma-FIB. It should be noted that some re-deposition from the FIB may be present across the samples, but as the same milling and polishing steps were used for each sample this should be similar across samples and the polishing steps were chosen with a view to minimizing this. The surfaces of the samples were protected with deposited Pt and then sectioned and polished using a constant voltage of 30 kV down to a current of 15 nA.

Young's modulus was measured according to the method set out in ASTM D695.

Electrochemical impedance spectroscopy (EIS) was carried out using a VMP-3 potentiostat (Biologic, France) with a voltage amplitude of 10 mV in the frequency range from 1 MHz to 0.01 Hz. The SE pellet was pressed at 370 MPa in a PEEK mould to make the pellet, and two carbon coated Al foil (10 mm diameter) current collectors were pressed onto the pellet under 300 MPa for 3 min. The ionic conductivity of the SE was measured under a 9 MPa of stack pressure using a home-made battery cell or <under a stack pressure of <1 MPa stack pressure using a coin cell (CR2032, Hoshen Co., Ltd, Japan), both at 30° C.

For symmetrical Li-Li cycling, two Li-metal anodes with a diameter of 12.7 mm and thickness of 100 μm were attached to each side of the ISE separator in the coin cell. Symmetrical cells were cycled at various current densities as mentioned in the results section.

Li-S full cells were assembled in coin cell and pouch cell. As a cathode, commercial cathode (BE-70E, NEI corp., 3.75 mg cm of sulphur loading, 12.7 mm diameter in coin cell, and 20 mm×20 mm dimension in pouch cell), which consisted of 70 wt. % sulfur, 20 wt. % carbon black and 10 wt. % poly (vinylidene flouride) binder, was used along with a Li-metal anode (100 μm thick, Sigma aldrich) which was polished and calendared before use to remove any surface layer. For Li-S cell, the amount of precursor solution for infiltration additionally injected in the cathode side, considering the sulphur loading (Electrolyte/Sulphur=10 μL/mg of S). Li-S cell cycling was carried out between 1.5 and 2.8 V at a constant 0.05 C after 3 activating cycles at a rate of 0.01 C, using a BCS-800 battery cycler (Biologic, France).

### Results and Discussion

### Solid Electrolyte Separator Characterisation

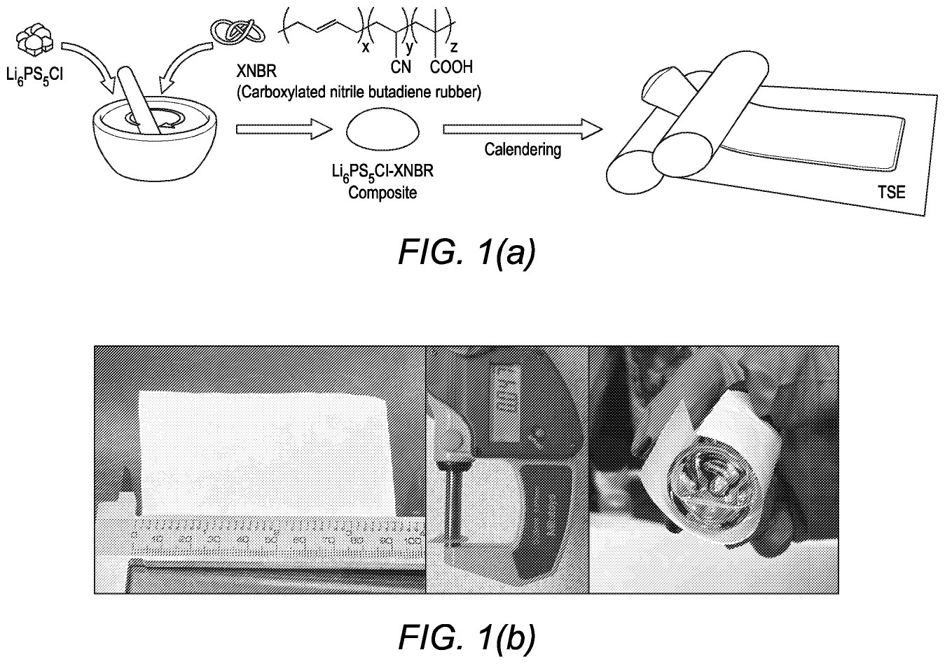

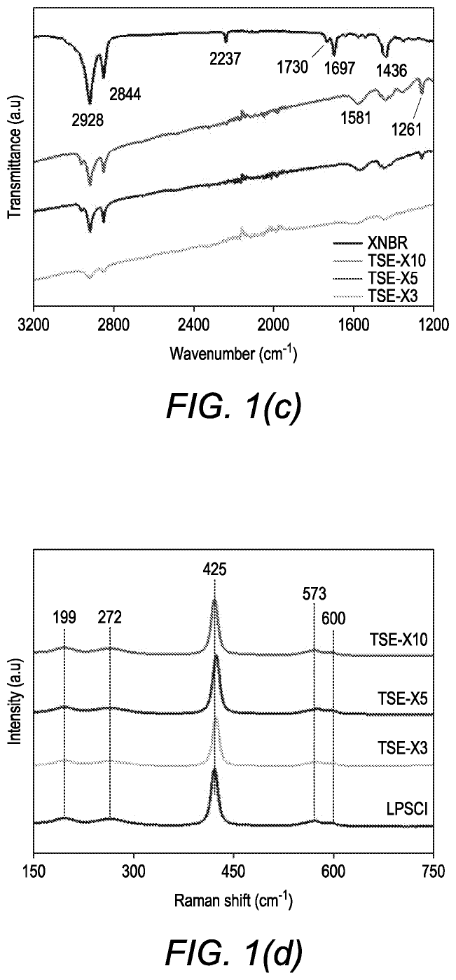

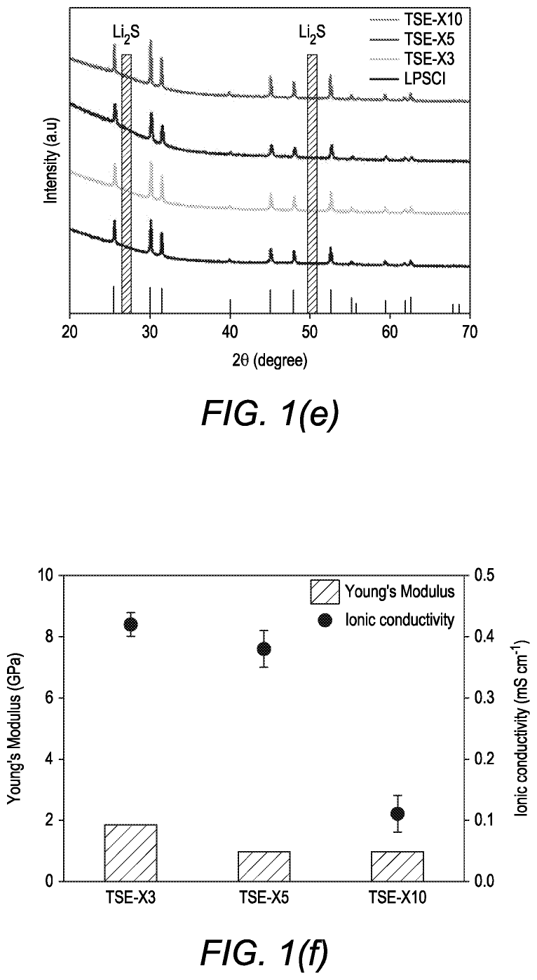

FT-IR was used to investigate the effects of the binder on intermolecular bonding. The addition of the binder results in a shift towards lower wavenumbers in the FT-IR spectra (FIG. 1c) for the peaks at 1730 and 1697 cm⁻¹, which are attributed to the carboxylic groups in XNBR (carbonyl stretching of mono and H-bonded carboxylic acid, respectively). The shift in the broad peaks near 1585 cm⁻¹ demonstrates the formation of carboxylates (—COO—) due to the reaction between the electron-rich functional groups (—COOH) by electron-accepting sites such as P⁵⁺ and Li⁺. The shift in corresponding FT-IR peaks towards lower wavenumbers supports this interpretation and implies the formation of intermolecular bonds between LPSCl and XNBR.

Raman spectroscopy and X-ray diffraction (XRD) analyses were conducted to confirm the chemical and structural stability of Li₆PS₅Cl in the solid electrolyte separators. The Raman spectra (FIG. 1d) exhibited peaks at 199, 272, 425, 573, and 600 cm⁻¹ across all samples, which can all be attributed to vibrational modes of the PS₄³⁻ within Li₆PS₅C.

From the XRD pattern of the solid electrolytes (FIG. 1e), prominent diffraction peaks at 25.5°, 30.0°, 31.4°, 45.0°, 47.9°, and 52.4° were indexed to the (220), (311), (222), (422), (511), and (440) LPSCl planes, respectively, which is consistent with the pattern for pure LPSCl without any evidence of decomposition to Li₂S.

These results confirm that the Li₆PS₅Cl remains chemically stable during preparation of the solid electrolyte separator.

The mechanical and electrochemical properties of the solid electrolyte separators were analysed. The Young's modulus and ionic conductivity results are shown in FIG. 1f and Table 1 below.

TABLE 1

| | |
|---|---|
| Solid | Ionic conductivity |
| electrolyte | (mS cm⁻¹ at 30° C.) |

Under 9 MPa (stack pressure)

| | |
|---|---|
| Pellet | 0.79 (±0.04) |
| TSE-X3 | 0.42 (±0.02) |
| TSE-X5 | 0.38 (±0.03) |
| TSE-X10 | 0.11 (±0.03) |

Thus as shown from the results in Table 1 and FIG. 1f, increasing the binder content improves the flexibility of the solid electrolyte separator (demonstrated by a decrease in Young's modulus), but as the binder is not ionically conductive, it also decreases its ionic conductivity. TSE-X3 therefore had the highest Young's modulus value of the solid electrolytes tested, and the highest ionic conductivity. Conversely, TSE-X10 comprised the lowest Young's modulus value, but had the lowest ionic conductive of the solid electrolytes tested. Hereinafter, further testing was conducted on TSE-X5, which comprised Young's modulus and ionic conductivity values between that of TSE-X3 and TSE-X10.

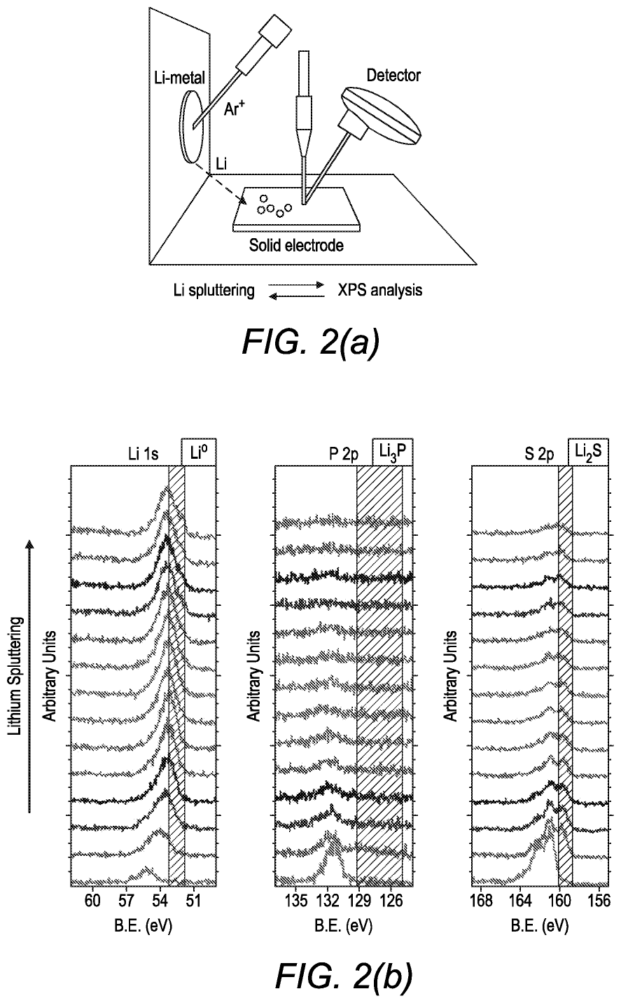

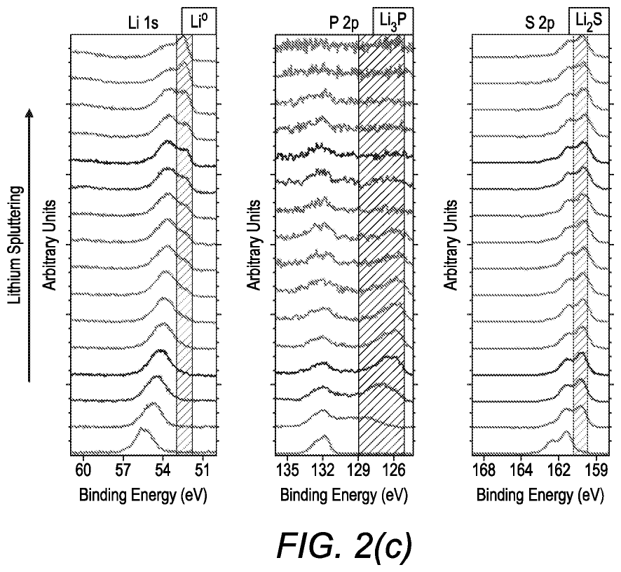

Sulphide solid electrolytes (SEs) are known to undergo decomposition on contact with Li-metal, forming a variably conductive interface consisting of Li₂S, LiCl, and LiₓP. This heterogeneous interface affects the Li plating/stripping behaviour, potentially leading to lower interfacial ionic conductivity, nonuniform deposition, accelerated Li-filament growth, and degradation during battery cycling. Therefore, the interfacial stability between Li-metal and the TSE was evaluated using X-ray photoelectron spectroscopy (XPS), and comparatively, Li-metal and a binder-free pellet-type LPSCl solid electrolyte (FIG. 2).

XPS was also carried out to further investigate the chemical evolution at the Li-metal and the solid electrolyte interface. XPS analysis was carried out with in-situ deposition of Li-metal on the solid electrolyte by an Ar⁺ beam as shown schematically in FIG. 2a. The XPS spectra obtained from the analysis of the TSE surface (FIG. 2b) showed a gradual shift in the Li 1s spectra towards lower binding energies. This suggests a reaction with the solid electrolyte surface to form a solid electrolyte interphase (SEI). Further deposition leads to the appearance of a feature characteristic of metallic Li (Li⁰) species observed at a binding energy near 52.5 eV.

Additionally, a doublet feature characteristic of Li₂S (highlighted in orange) was noticed in the S 2p spectra. The formation of Li₂S is consistent with the reported components of the SEI between Li-metal and LPSCl.

In the P 2p spectra, the formation of LiₓP is difficult to observe, unlike in the binder-free solid electrolyte pellet (FIG. 2c).

These results demonstrate that the prepared solid electrolyte separator forms a stable solid electrolyte interface (SEI) in which Li₂S was the dominant component in contact with Li-metal, and was observably different from that formed with the binder-free solid electrolyte pellet. Therefore, this suggests that XNBR also affects the interfacial chemistry and helps improve its stability.

### Cell Evaluation

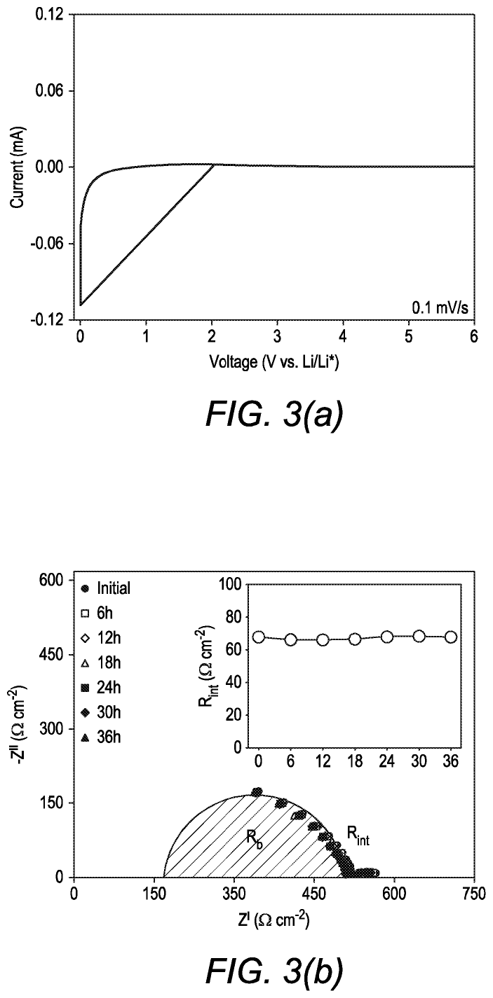

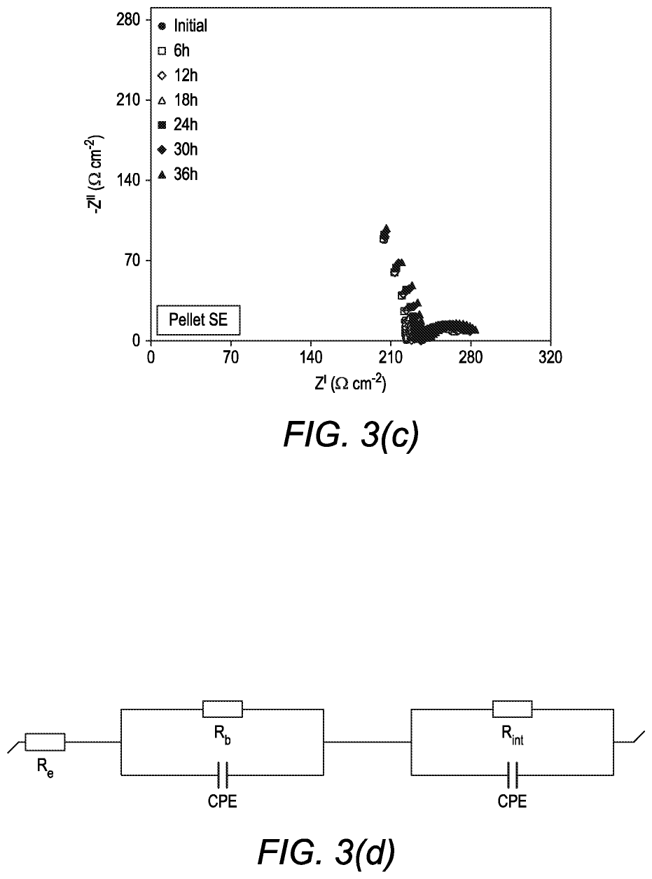

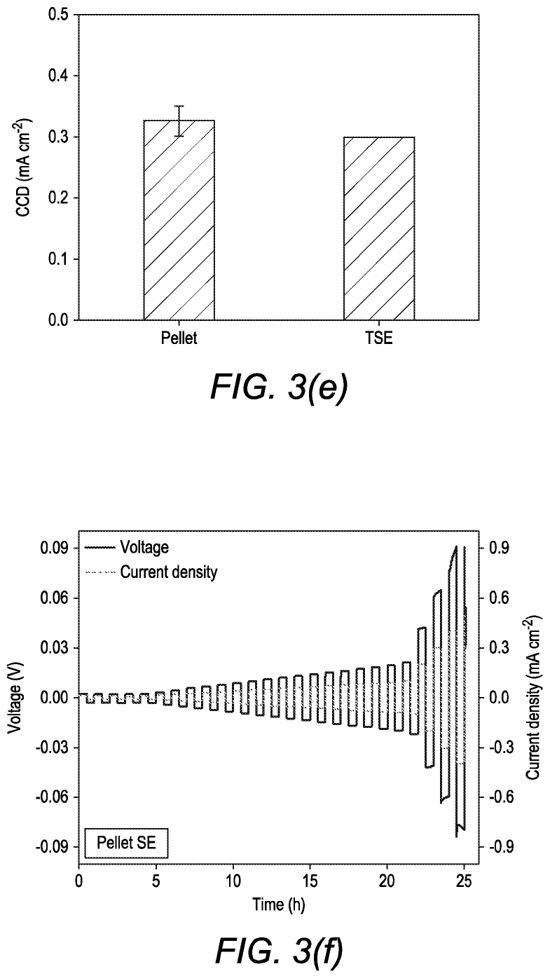

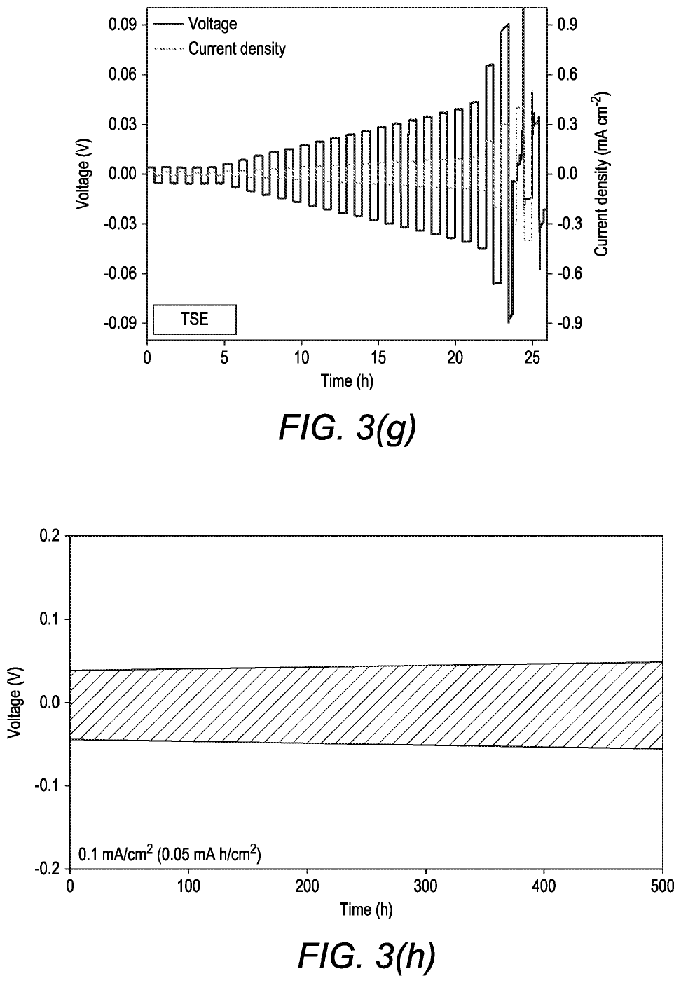

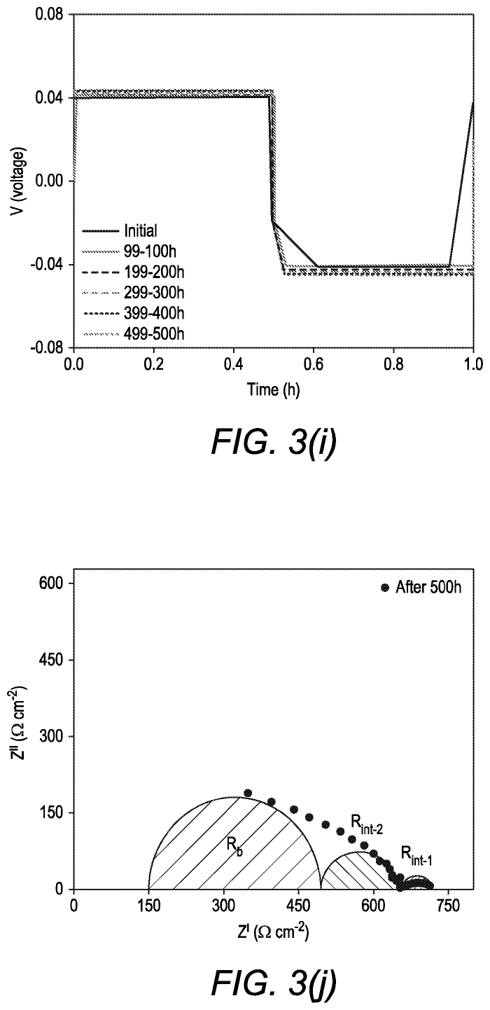

To determine the limits of practical use for this SE system with Li-metal anode, linear sweep voltammetry (LSV), electrochemical impedance spectroscopy (EIS), and critical current density (CCD) tests were run to investigate its electrochemical limitations (FIG. 3). FIG. 3a shows the electrochemical stability of the TSE separator measured via linear sweep voltammetry (LSV) at 0.1 mV s⁻¹. The TSE exhibited a wide electrochemical stability window up to 6.0 V as expected from its majority sulphide composition. The stability of both these components falls within the necessary range for the TSEs to be used in solid-state LiSBs. Symmetric Li-Li coin cells were assembled and evaluated under practical conditions with no additional stack pressure (at 30° C., <1 MPa inherent to the coin cell) to test the EIS and CCD with a SE pellet, and TSE.

FIGS. 3b and 3c display the impedance spectra of the TSE and a SE pellet, respectively, assembled into symmetric Li/SE/Li cells. Using the fitted equivalent circuit model (FIG. 3d), the Nyquist plots were separated into two semicircles representing the interfacial resistance (Rᵢₙₜ) between the Li-metal and SE, and the bulk resistance of the SE (R_{b}). Even after maintaining contact between Li-metal and the TSE for over 36 hours, changes in Rᵢₙₜ were insignificant, indicating a stable interface between the SE and Li (FIG. 3b). Meanwhile, in the case of the pellet SE, Rᵢₙₜ and R_{b} continually increased over the same time period, demonstrating the high reactivity between Li-metal and LPSCl (FIG. 3c). These results also are consistent with the formation of a stable SEI layer between TSE and Li-metal which is indicated in FIG. 2.

Based on the stable electrochemical characteristics of the TSE with Li-metal, Li plating/stripping behaviour was investigated with increasing current density from 0.01 to 0.4 mA cm⁻² for each electrolyte (FIG. 3e, 3f, 3g and Table 2). As shown in FIG. 3e, 3f, and 3g, on average the symmetrical Li-Li cell with a ˜600 μm thick pellet SE developed a short-circuit after applying 0.325 mA cm⁻². Meanwhile, the <50 μm thick TSE ( 1/12 as thick as the pellet) demonstrated a similar CCD, 0.3 mA cm⁻². This performance could be attributed to the dense microstructure of the TSE, with its low porosity (average 4.47%).

In addition, to evaluate the stability of TSE for use in long-term cycling, a symmetric Li-Li cell was assembled and cycled at 0.1 mA cm⁻² (0.05 mAh cm⁻²) for 500 h (FIG. 3h). After cycling, the overpotential and interfacial resistance were largely unchanged (FIGS. 3i and 3j), and the interface between TSE and Li-metal maintained good contact during repeated Li plating/striping without a critical short circuit.

Thus, this TSE is practical to manufacture commercially, shows good stability against Li-metal, and can withstand long-term battery cycling without failure.

TABLE 2

| | Critical current density |
|---|---|
| Solid electrolyte | (mA cm⁻²) |
| Solid electrolyte pellet | 0.325 (±0.025) |
| Integrated solid electrolyte | 0.3 (±0) |
| separator | |

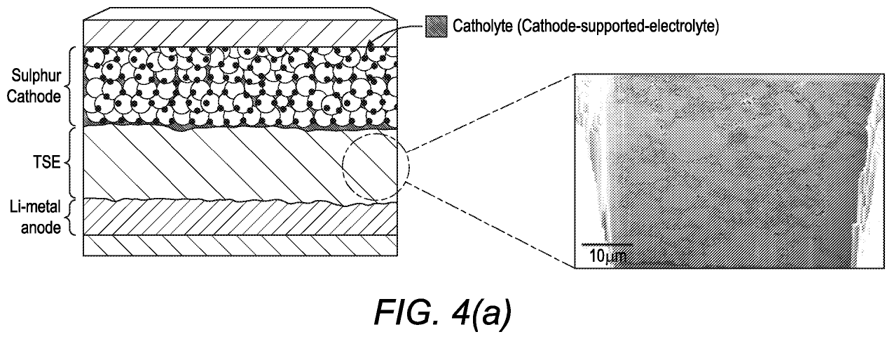

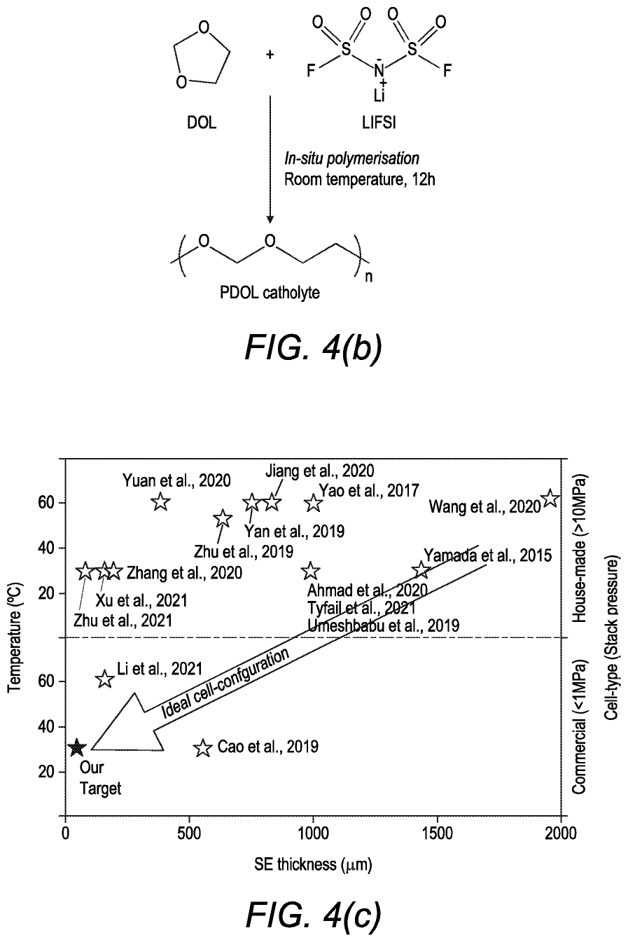

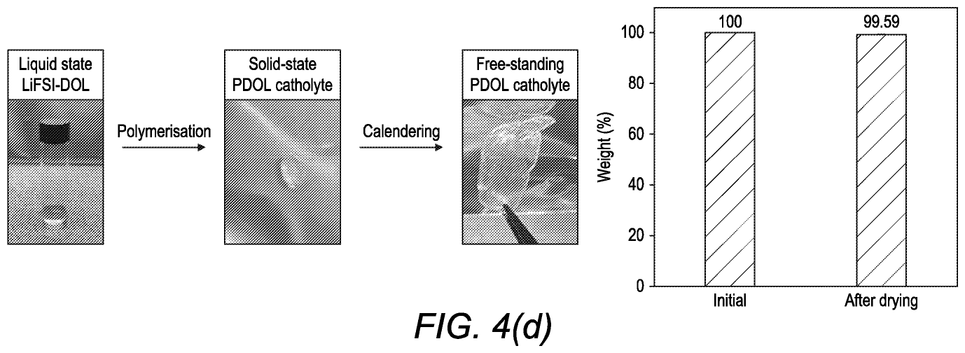

An integrated solid-state battery design with a tape-cast sulphur cathode containing a cathode-supported electrolyte (catholyte), as shown in FIG. 4a was prepared. The catholyte comprises ionically-conducting polydioxolane (PDOL) that provides chemically stable and ionically conducting pathways across the cathode-electrolyte interface (cathode/TSE). This was achieved by infiltrating 2M lithium bis(fluorosulfonyl)imide (LiFSI) dissolved in 1,3-dioxolane (DOL) into the sulphur cathode upon complete assembly of the cell. The solution then undergoes in-situ polymerisation and forms polydioxolane (PDOL), with the LiFSI acting as the initiator (FIG. 4b).

The choice of DOL as a soluble precursor along with the subsequent in situ polymerisation step here, is deliberate. Firstly, other non-polar solvents such as toluene, xylene, benzene, etc. easily dissolve sulphur-based materials, despite their apparent chemical compatibility with sulphide SEs. This complicates fabrication of film-type cathode composites with high sulphur contents. Secondly, DOL polymerises into an ionically-conductive solid (˜0.308 mS cm⁻¹), maintaining the solid-state nature of the TSE at the end of the in-situ polymerisation process. This is demonstrated by negligible change in weight of the catholyte before and after polymerization of LiFSI-DOL, when left to dry in vacuum at 80° C. over a 24 h period (FIG. 4c). Moreover, the catholyte forms ionic pathways within the cathode and TSE, while also enhancing contact between these layers through improved wetting. The infiltration of PDOL in this manner effectively enables operation of the assembled cell under practically relevant stack pressures (<1 MPa) and at room temperature, which is a step toward an ideal solid-state battery system. (FIG. 4d).

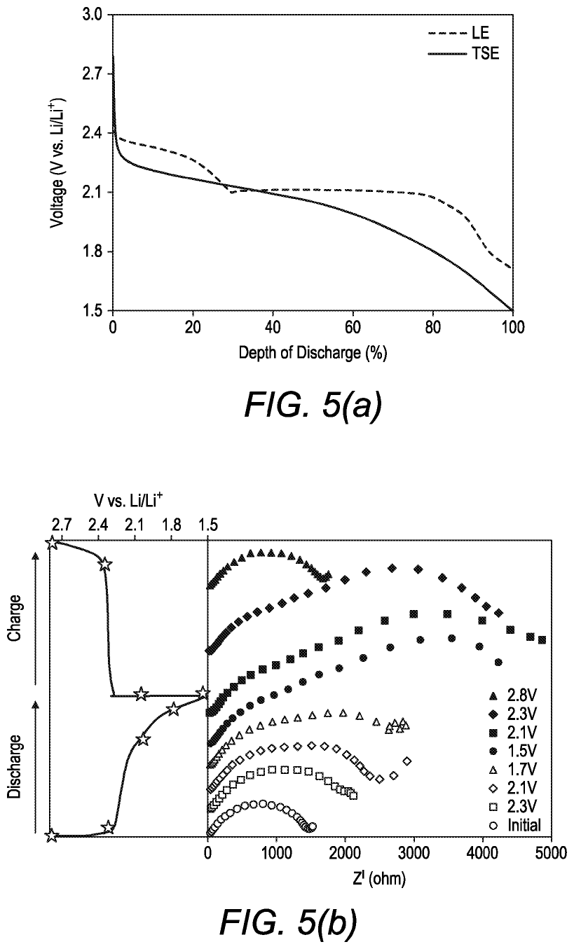

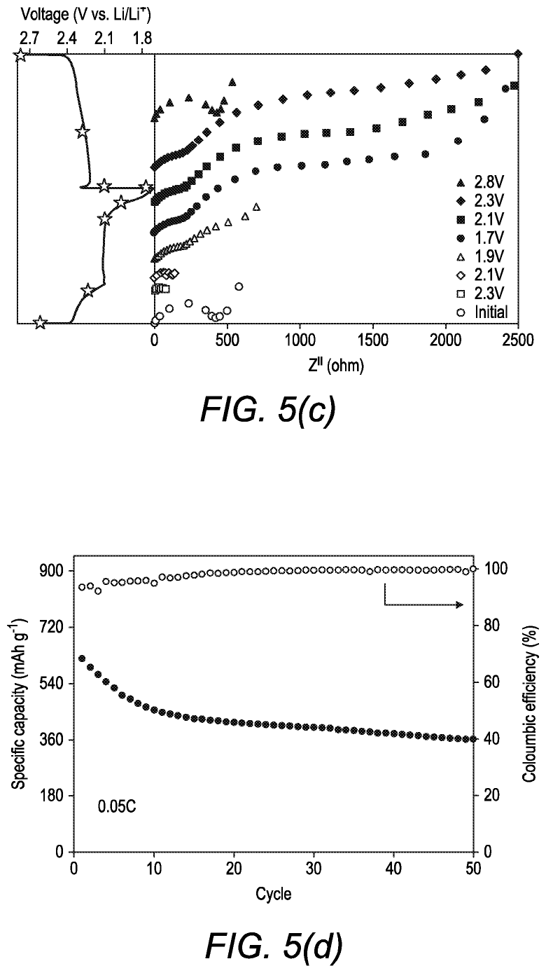

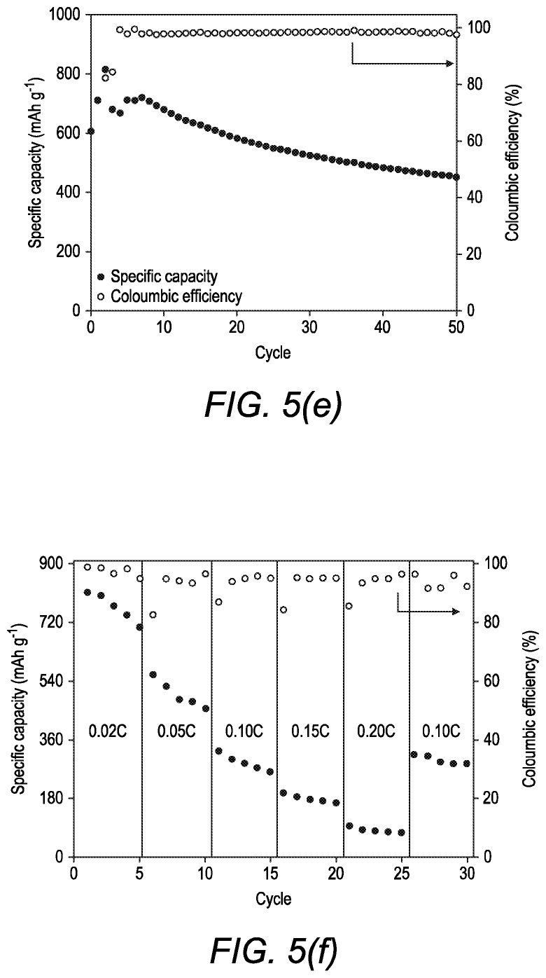

The TSEs were then assembled into full cells with a commercial S-cathode (3.54 mg cm⁻² of S-loading), a Li-metal anode (100 μm thick) and tested under practical conditions (<1 MPa stack pressure, at 30° C.). Galvanostatic initial discharge profiles of Lithium-Sulphur batteries (LiSBs) and a liquid electrolyte (1M LiTFSI in DOL/DME with 0.8M LiNO₃) and the TSE were compared (FIG. 5a). While the Li-S cell with liquid electrolyte (LE) showed two plateaus in the voltage profile, the solid-state Li-S cell with TSE only produced one discharge plateau at ˜2.15 V, which indicates a direct reaction from S₈ to Li₂S (S+2Li⁺+2e⁻=Li₂S), as is seen in conventional solid-state LiSBs with pellet solid electrolytes.

To further investigate the reaction processes occurring through discharging and charging, EIS spectra were collected at various points in the charge-discharge cycle for the cells with a TSE and LE as shown in FIGS. 5b and 5c, respectively. The direct solid-solid conversion reaction with the TSE caused the absolute change in the resistance to be much larger than with the LE. During discharge from the initial state to 1.5 V, the charge transfer resistance gradually increased due to direct conversion of solid S₈ to Li₂S, while the presence of a soluble liquid acting as an intermediary meant that the LE cell demonstrated lower intermediate resistances. On recharge, the impedance spectra reverted to a shape similar to that of the initial state, indicating the conversion of Li₂S back to S₈. This shows that the TSE can reversibly undergo cycling without significant changes in resistance or trapping of S-species.

The TSE was cycled in the solid-state LiSB coin cells at 0.05 C, as shown in FIG. 5d. The coin cell presented stable cycling and a high coulombic efficiency (˜99%). Moreover, after 50 cycles, the solid-state LiSB showed a discharge capacity of 410 mAh g⁻¹, which is comparable to Li-S cells using a LE (433 mAh g⁻¹, FIG. 5e). In FIG. 5f, the prepared solid-state Li-S cell presented stable battery cycling at the different current densities from 0.02 C to 0.2 C. The cell delivered 722, 484, 314, 176, 90 and 310 mAh g⁻¹ (at 0.02, 0.05, 0.1, 0.15, 0.2, and 0.1C, respectively), and showed excellent reversibility, even after the current density returned to 0.1C (98.7% retention). This also indicates the formation of stable interfaces between the SE and cathode, without significant effects from the polysulphide shuttle or Li-filament growth.

### CONCLUSIONS

A thin (less than 50 μm) and scalable solid electrolyte separator was manufactured using a facile method. A full cell can also be prepared using the solid electrolyte separator integrated with an ion-conductive cathode-supported electrolyte. The integrated solid-state system demonstrated outstanding electrochemical performance under practical conditions (at 30° C. and <1 MPa stack pressure), including a comparable CCD of 0.3 mA cm⁻² and stable cycling for 500 h at 0.1 mA cm⁻² in symmetric Li-Li cells, and stable cycling over 50 cycles in Li-S full cells using a Li metal anode and commercial sulphur cathode.

1. A solid electrolyte separator for an electrochemical storage device comprising:
an electrolyte comprising a lithium-ion conductive compound; and
a binder comprising a copolymer,
wherein the lithium-ion conductive compound comprises sulfur, and the copolymer has a repeating unit comprising a carboxylic acid group or a conjugate base thereof.

2. The solid electrolyte separator according to claim 1, wherein the copolymer is a block copolymer.

3. The solid electrolyte separator according to claim 1 or claim 2, wherein the repeating unit comprising a carboxylic acid group or a conjugate base thereof is derived from acrylic acid, methacrylic acid or maleic acid.

4. The solid electrolyte separator according to any one of claims 1 to 3, wherein the copolymer is a carboxylated rubber, poly(ethylene-co-acrylic acid), poly(ethylene-co-methacrylic acid) or carboxylated polystyrene.

5. The solid electrolyte separator according to claim 4, wherein the carboxylated rubber is a carboxylated nitrile butadiene rubber or a carboxylated styrene butadiene rubber.

6. The solid electrolyte separator according to any one of claims 1 to 5, wherein the copolymer has a total content of the carboxylic acid group and the conjugate base thereof of less than or equal to 15 wt %.

7. The solid electrolyte separator according to any one of claims 1 to 6, which comprises the binder in a total amount of from 3.00 to 10.00 wt %, preferably about 5.00 wt %.

8. The solid electrolyte separator according to any one of claims 1 to 7, wherein the electrolyte is a sulfide solid electrolyte.

9. The solid electrolyte separator according to any one of claims 1 to 8, wherein the electrolyte is an argyrodite lithium ionic conductor of the general formula Li₇₋ₚBS₆₋ₚXₚ, wherein B is phosphorous or arsenic, X is Cl, Br or I, and p is between 0 and 1, preferably the electrolyte is Li₆PS₅Cl (LPSCl).

10. The solid electrolyte separator according to any one of claims 1 to 8, wherein the electrolyte is of the general formula Li_{4-q}Ge_{(1-q)}P_{q}S₄, where q is between 0 and 1.

11. The solid electrolyte separator according to any one of claims 1 to 8, wherein the electrolyte is selected from Li₂S—P₂S₅—LiCl, Li₂S—SiS₂, LiI—Li₂S—SiS₂, LiI—Li₂S—P₂S₅, LiI—Li₂S—P₂O₅, LiI—Li₃PO₄—P₂S₅, Li₂S—P₂S₅, Li₃PS₄, Li₇P₃S₁₁, LiI—Li₂S—B₂S₃, Li₃PO₄—Li₂S—Si₂S, Li₃PO₄—Li₂S—SiS₂, LiPO₄—Li₂S—SiS, Li₁₀GeP₂S₁₂, Li_{9.54}Si_{1.74}P_{1.44}S_{11.7}Cl_{0.3}, Li₇P₃S₁₁, LiₓPS_{y}Cl_{z}, LiₓPS_{y}Br_{z}, LiₓPS_{y}Cl_{z}Br_{1-z}, LixPSyF_{z}, LiₓPS_{y}F_{z}Cl_{1-z} and LiₓPS_{y}F_{z}Br_{1-z}, wherein x, y and z is each greater than 0.

12. The solid electrolyte separator according to any preceding claim, which has a thickness of 50 μm or less.

13. The solid electrolyte separator according to any preceding claim, which has an ionic conductivity of from 0.1 to 1.0 mS cm⁻¹.

14. The solid electrolyte separator according to any preceding claim, which has a Young's modulus of from 0.5 to 5.0 GPa.

15. A masterbatch product for preparing a solid electrolyte separator, wherein the masterbatch product comprises:
a lithium-ion conductive compound;
a copolymer, and
a solvent,
wherein the lithium-ion conductive compound comprises sulfur, and the copolymer has a repeating unit comprising a carboxylic acid group or a conjugate base thereof.

16. The masterbatch product according to claim 15, wherein the lithium-ion conductive compound is as defined in any one of claims 8 to 11 and/or the copolymer is as defined in any one of claims 2 to 7.

17. A method of manufacturing a solid electrolyte separator for an electrochemical storage device, the method comprising:
(i) mixing a lithium-ion conductive compound, a copolymer and a solvent, wherein the lithium-ion conductive compound comprises sulfur, and the copolymer has a repeating unit comprising a carboxylic acid group or a conjugate base thereof to form a masterbatch product; and
(ii) calendaring the masterbatch product to form a separator.

18. The method according to claim 17, wherein the solvent is a non-polar solvent, preferably an aromatic non-polar solvent.

19. The method according to claim 18, wherein the non-polar solvent is toluene, xylene or benzene.

20. An electrochemical storage device comprising:
a first electrode;
a second electrode; and
a solid electrolyte separator according to any one of claims 1 to 14 disposed between the first electrode and the second electrode.

21. The electrochemical storage device according to claim 20, wherein the solid electrolyte separator further comprises an integrated supporting electrolyte.

22. The electrochemical storage device according to claim 21 wherein the integrated supporting electrolyte comprises polydioxolane (PDOL).

23. The electrochemical energy storage device according to any one of claims 20 to 22, wherein the first electrode is a cathode and the second electrode is an anode.

24. The electrochemical energy storage device according to any one of claims 20 to 23, wherein the first electrode comprises sulphur.

25. The electrochemical energy storage device according to any one of claims 20 to 24, wherein the second electrode comprises lithium.
